(19) United States
(12) Patent Application Publication
(10) Pub. No.: US 2018/0273767 A1
(43) Pub. Date: Sep. 27, 2018

(54) THERMAL SPRAY SLURRY

(71) Applicant: FUJIMI INCORPORATED, Kiyosu-shi (JP)

(72) Inventors: Takaya MASUDA, Aichi (JP); Hiroyuki IBE, Aichi (JP); Kazuya SUGIMURA, Aichi (JP)

(73) Assignee: FUJIMI INCORPORATED, Kiyosu-shi (JP)

(21) Appl. No.: 15/923,862

(22) Filed: Mar. 16, 2018

(30) Foreign Application Priority Data
Mar. 21, 2017 (JP) 2017-054334

(51) Int. Cl. C09D 1/00; C23C 4/11; C23C 4/134; C01F 17/00

(52) U.S. Cl. CPC C09D 1/00; C01F 17/0043; C23C 4/134; C23C 4/11

(57) ABSTRACT

Provided is thermal spray slurry capable of forming a dense coating by thermal spraying while suppressing cracks. Thermal spray slurry includes thermal spray particles and a dispersion medium in which these thermal spray particles are dispersed. These thermal spray particles have the cumulative frequency of the particle diameter of 13.2 μm in the volume-based cumulative particle diameter distribution that is 95% or more, and the cumulative frequency of the particle diameter of 0.51 μm that is 8% or less.

### BACKGROUND OF THE INVENTION

### Field of the Invention

The present invention relates to thermal spray slurry.

### Description of the Related Art

A thermal spraying method is a technology of forming a coating on a substrate by injecting a thermal spray feedstock onto a substrate. Another thermal spraying method is also known in the art, in which slurry obtained by dispersing thermal spray particles into a dispersion medium is used as the thermal spray feedstock (for example, see PTL 1). Although thermal spraying using such slurry easily forms a dense (with less pores) coating, the coating may have cracks.

### CITATION LIST

### Patent Literature

PTL 1: JP 2010-150617 A

### SUMMARY OF THE INVENTION

An object of the present invention is to provide thermal spray slurry capable of forming a dense coating by thermal spraying while suppressing cracks.

Thermal spray slurry according to one aspect of the present invention includes thermal spray particles and a dispersion medium in which the thermal spray particles are dispersed, where cumulative frequency of the thermal spray particles of a particle diameter of 13.2 μm in volume-based cumulative particle diameter distribution is 95% or more, and cumulative frequency of the thermal spray particles of particle diameter of 0.51 μm in the volume-based cumulative particle diameter distribution is 8% or less.

The present invention allows the formation of a dense coating by thermal spraying while suppressing cracks.

### DESCRIPTION OF THE PREFERRED EMBODIMENTS

The following describes one embodiment of the present invention in details. The following embodiment illustrates one example of the present invention, and the present invention is not limited to the embodiment. The following embodiment can be changed and modified variously, and the present invention can cover such a changed or modified embodiment.

Thermal spray slurry of the present embodiment contains thermal spray particles and a dispersion medium in which these thermal spray particles are dispersed. These thermal spray particles have the cumulative frequency of the particle diameter of 13.2 μm in the volume-based cumulative particle diameter distribution that is 95% or more, and the cumulative frequency of the particle diameter of 0.51 μm that is 8% or less.

Thermal spraying using such thermal spray slurry enables the formation of a dense coating while suppressing cracks because the rate of the thermal spray particles having a small particle diameter (particle diameter of 0.51 μm or less) is small.

The following describes the thermal spray slurry of the present embodiment in more details.

Thermal spray slurry of the present embodiment contains thermal spray particles and a dispersion medium in which these thermal spray particles are dispersed. The thermal spray slurry can be manufactured by mixing the thermal spray particles and the dispersion medium so as to disperse the thermal spray particles in the dispersion medium.

Types of the thermal spray particles are not limited especially, and metal oxides (ceramics), metals, resin, cermet or the like may be used for the thermal spray particles.

Types of the metal oxides are not limited especially, and yttrium oxide (Y₂O₃), aluminum oxide (Al₂O₃), silicon oxide (SiO₂), titanium oxide (TiO₂), or zirconium oxide (ZrO₂) may be used, for example.

The thermal spray particles have the cumulative frequency of the particle diameter of 13.2 μm in the volume-based cumulative particle diameter distribution that is 95% or more, and the cumulative frequency of the particle diameter of 0.51 μm that is 8% or less, and may have the cumulative frequency of the particle diameter of 5.1 μm that is 75% or more. Thermal spraying using such thermal spray particles enables the formation of a denser coating (with less pores) having excellent surface roughness Ra.

According to PTL 1, the yttrium oxide particles have the average particle diameter (volume average diameter) of 6 μm or less from the viewpoint of forming a dense coating by thermal spraying. According to this literature, a smaller average particle diameter of yttrium oxide particles leads to smaller porosity of the coating formed with the thermal spray slurry. As a result, such a coating can have improved resistance to plasma erosion. On the contrary, the present inventors found that a too smaller particle diameter may cause cracks in the coating easily, and that the cumulative frequency of the particle diameter of 0.51 μm limited to 8% or less can suppress cracks and enables the formation of a dense coating by thermal spraying.

The concentration of the thermal spray particles in the thermal spray slurry of the present embodiment is not limited especially, and the concentration may be 5 mass % or more and 50 mass % or less, for example, and preferably 30 mass % or more and 50 mass % or less. Such a concentration of the thermal spray particles of 30 mass % or more enables a sufficiently large thickness of the coating that is manufactured from the thermal spray slurry per unit time.

The viscosity of the thermal spray slurry of the present embodiment is not limited especially, and the viscosity may be 3.7 mPa·s or more and 4.6 mPa·s or less. Such thermal spray slurry can lead to the advantageous effect of smaller surface roughness of the coating.

The type of the dispersion medium may include, but not particularly limited to, for example, water, an organic solvent, or a mixed solvent obtained by mixing two or more types of these solvents. The organic solvent may include, for example, alcohols such as methanol, ethanol, n-propyl alcohol, and isopropyl alcohol.

The thermal spray slurry according to this embodiment may further contain components other than the thermal spray particles and the dispersion medium as desired. For example, in order to improve performance of the thermal spray slurry, an additive may be further contained as necessary. The additive may include, for example, a dispersant, a viscosity adjusting agent, a coagulant, a re-dispersibility improver, an antifoaming agent, an antifreezing agent, an antiseptic agent, and a fungicide. The dispersant has a property of improving dispersion stability of the thermal spray particles in the dispersion medium, and includes a polymer type dispersant such as polyvinyl alcohol and a surfactant type dispersant. Such an additive may be used solely, or two or more of them may be used in combination.

### Examples

The following describes the present invention more specifically by way of Examples and Comparative Examples.

Yttrium oxide particles as the thermal spray particles were mixed in water as the dispersion medium for dispersion, whereby nine types of thermal spray slurries were manufactured. These nine types of thermal spray slurries were manufactured by using any one of nine types of yttrium oxide particles having different properties (the cumulative frequency of the particle diameter of 0.51 μm, 5.1 μm and 13.2 μm in the volume-based cumulative particle diameter distribution, and the particle diameter corresponding to 50% of the cumulative frequency counted from a small particle diameter in the volume-based cumulative particle diameter distribution (hereinafter called “D50”)).

All of the nine types of thermal spray slurries had the concentration of yttrium oxide particles of 30 mass %. Table 1 shows the properties of the yttrium oxide particles, i.e., about the above-stated three types of cumulative frequencies and D50. Table 1 shows the viscosity of the nine types of thermal spray slurries.

The particle diameter of the yttrium oxide particles and the volume-based distribution of cumulative particle diameter were measured with a laser diffraction/scattering type particle-diameter distribution measurement device LA-300 produced by Horiba, Ltd. The viscosity of the thermal spray slurry was measured with a B-type viscometer.

TABLE 1

| | | Comp. | Comp. | | | | | | | |
|---|---|---|---|---|---|---|---|---|---|---|
| | | Ex. 1 | Ex. 2 | Ex. 1 | Ex. 2 | Ex. 3 | Ex. 4 | Ex. 5 | Ex. 6 | Ex. 7 |
| D50 (μm) | | 1.8 | 2.0 | 2.2 | 2.5 | 2.6 | 3.3 | 4.1 | 5.2 | 6.4 |
| Cumulative | 0.51 μm | 11.3 | 9.8 | 7.5 | 5.4 | 0.8 | 3.1 | 3.0 | 2.6 | 1.4 |
| frequency | 5.1 μm | 91.3 | 91.0 | 91.5 | 89.6 | 88.4 | 75.3 | 63.7 | 49.0 | 32.9 |
| (%) | 13.2 μm | 99.9 | 100.0 | 100.0 | 100.0 | 100.0 | 99.3 | 98.6 | 97.3 | 95.3 |

| | | | | | | | | | |
|---|---|---|---|---|---|---|---|---|---|
| Viscosity (cP) | — | 4.8 | 4.6 | 4.0 | 3.9 | 3.7 | 2.1 | — | — |
| Presence of cracks | x | x | ∘ | ∘ | ∘ | ∘ | ∘ | ∘ | ∘ |
| Porosity | x | x | ∘ | ∘ | ∘ | ∘ | Δ | Δ | Δ |
| Surface roughness Ra | ∘ | ∘ | ∘ | ∘ | ∘ | ∘ | Δ | Δ | Δ |

Next, a substrate was prepared, and each of the above-stated thermal spray slurries was thermal-sprayed to the substrate to forma coating on the surface of the substrate. This substrate was made of aluminum. The surface of the substrate for thermal spraying underwent abrasive blasting to have surface roughness Ra of 1.1 μm.

The surface roughness (arithmetic average roughness) Ra was measured according to the method specified in JIS B0601. More specifically surface roughness Ra was measured at five points selected at random of the surface of the substrate (thermal spray target surface) using a surface roughness meter “SV-3000S CNC” produced by Mitutoyo Corporation, and the average of the surface roughness Ra at the measured five points was used as the surface roughness Ra of the surface of the substrate. The standard length and the cutoff value were 0.8 mm.

Thermal spraying using such thermal spray slurry was performed using a plasma thermal spraying device 100HE produced by Progressive Surface Corporation. The conditions of thermal spraying were as follows.

Flow rate of argon gas: 180 NL/min.

Flow rate of nitrogen gas: 70 NL/min.

Flow rate of hydrogen gas: 70 NL/min.

Plasma output power: 105 kW

Thermal spraying distance: 76 mm

Traverse speed: 1500 mm/s

Thermal spraying angle: 90°

Slurry feeding rate: 38 mL/min.

Number of passes: 50

Next, thermal sprayed coating formed on the substrate by thermal spraying was evaluated. More specifically, the presence or not of cracks, density (porosity) and surface roughness Ra were evaluated. Firstly the presence or not of cracks was evaluated as follows.

A substrate having the coating formed was cut, and was embedded into a two-type mixed curable resin. Then, the obtained embedded body was polished to mirror-polish the cross section of the coating. The presence or not of cracks was checked by observing this cross section with a scanning electron microscope. Table 1 shows the result. Table 1 shows the mark x for the coating having cracks and the mark ∘ for the coating not having cracks.

Density (porosity) was evaluated as follows. An image of the cross section of the coating in the embedded body used for the evaluation of the cracks was captured to 1000-fold using a microscope. The obtained image data was analyzed using image analysis software Image-Pro Plus produced by Nippon Roper K.K. to calculate the porosity. Image analysis was to binarize an image to separate a part of the pores and a part of solid phase, and the porosity (%) was calculated, which was defined as the ratio of the area of the part of the pores to the overall cross-sectional area. Table 1 shows the result. Table 1 shows the mark x when cracks were generated at the coating and so measurement of the porosity failed, the mark Δ when the porosity exceeded 1% and was 3% or less, and the mark ∘ when the porosity was 1% or less.

Surface roughness Ra was evaluated as follows. The surface roughness (arithmetic average roughness) Ra of the coating formed by thermal spraying on the substrate was measured by the method specified in JIS B0601. More specifically surface roughness Ra was measured at five points selected at random of the surface of the coating using a surface roughness meter “SV-3000S CNC” produced by Mitutoyo Corporation, and the average of the surface roughness Ra at the measured five points was used as the surface roughness Ra of the coating. The standard length and the cutoff value were 0.8 mm respectively. Table 1 shows the result. Table 1 shows the mark ∘ when the measurement of surface roughness Ra was less than 1.0 μm, and the mark Δ when the measurement was 1.0 μm or more and 1.5 μm or less.

As is understood from the result of Table 1, the coatings in Comparative Examples 1 and 2 had cracks generated, and so the measurement of porosity failed. On the contrary, the coatings in Examples 1 to 7 had no cracks, small porosity and excellent surface roughness. Especially Examples 1 to 4 had particularly small porosity and very excellent surface roughness.

1. Thermal spray slurry comprising: thermal spray particles; and a dispersion medium in which the thermal spray particles are dispersed, wherein cumulative frequency of the thermal spray particles of a particle diameter of 13.2 μm in volume-based cumulative particle diameter distribution is 95% or more and cumulative frequency of the thermal spray particles of particle diameter of 0.51 μm in the volume-based cumulative particle diameter distribution is 8% or less.

2. The thermal spray slurry according to claim 1, wherein, the cumulative frequency of the thermal spray particles of a particle diameter of 5.1 μm in the volume-based cumulative particle diameter distribution is 75% or more.

3. The thermal spray slurry according to claim 1, wherein the thermal spray slurry has viscosity of 3.7 mPa·s or more and 4.6 mPa·s or less.

4. The thermal spray slurry according to any one of claim 1, wherein the thermal spray particles are particles of metal oxide.

5. The thermal spray slurry according to claim 4, wherein the metal oxide is yttrium oxide.

6. The thermal spray slurry according to claim 2, wherein the thermal spray slurry has viscosity of 3.7 mPa·s or more and 4.6 mPa·s or less.

7. The thermal spray slurry according to claim 2, wherein the thermal spray particles are particles of metal oxide.

8. The thermal spray slurry according to claim 3, wherein the thermal spray particles are particles of metal oxide.

9. The thermal spray slurry according to claim 7, wherein the metal oxide is yttrium oxide.

10. The thermal spray slurry according to claim 8, wherein the metal oxide is yttrium oxide.
